(19) United States
(12) Patent Application Publication
(10) Pub. No.: US 2026/0062046 A1
(43) Pub. Date: Mar. 5, 2026

(54) STROLLER CUP HOLDER

(71) Applicant: MONAHAN PRODUCTS, LLC, Rockland, MA (US)

(72) Inventors: Carl J. Sukeforth, Milton, MA (US); Grace Ells, Boston, MA (US); Eric Howard Perlman, Weymouth, MA (US); Ivan Yu, Newton, MA (US)

(21) Appl. No.: 18/821,180

(22) Filed: Aug. 30, 2024

(51) Int. Cl. B62B 9/26

(52) U.S. Cl. CPC B62B 9/26

(57) ABSTRACT

Container holding systems are disclosed. The system includes a clamp configured to be mounted on a frame of a stroller. The clamp includes a first clamping portion connectable to a second clamping portion by a hinge. The clamp includes a retaining clip integrated into the clamp. The retaining clip includes a flange spaced a distance from an outer surface of the clamp. The system further includes a container holder configured to be releasably secured to the flange of the retaining clip. The container holder includes a recess dimensioned to slide over the retaining clip on the frame of the stroller. Methods of releasably securing a container holder to a clamp are also disclosed.

### BACKGROUND

Aspects and embodiments of the present disclosure are generally directed to container holding systems, such as cup and phone holders, that are connectable to a stroller or another type of child conveyance device.

### SUMMARY

In accordance with some aspects of the present disclosure, there is provided a container holding system. The system may include a clamp configured to be mounted on a frame of a stroller. The clamp may include a first clamping portion connectable to a second clamping portion by a hinge. The system may include a retaining clip integrated into the clamp. The retaining clip may include a flange spaced a distance from an outer surface of the clamp. The system further may include a container holder configured to be releasably secured to the flange of the retaining clip. The container holder may include a recess dimensioned to slide over the retaining clip on the frame of the stroller.

In some embodiments, the retaining clip may include a first section integrated into the first clamping portion and a second section integrated into the second clamping portion.

In some embodiments, when the clamp is secured to the frame of the stroller, the first section and the second section interconnect with one another to form the flange of the retaining clip.

In further embodiments, the first section and the second section, when engaged, may form a latch constructed and arranged to open the clamp when disengaged.

In some embodiments, the flange embodies an annular or polygonal, e.g., square, rectangular, pentagonal, hexagonal, or higher order n-gon, profile in cross-section.

In some embodiments, the container holder may be positioned orthogonally to the latch when mated to the retaining clip. The profile shape of the flange of the retaining clip may limit rotational motion of the container holder.

In some embodiment, the retaining clip may be configured to be received by the recess of the container holder. In further embodiments, the retaining clip may maintain the container holder in a position that is substantially vertical relative to the clamp.

In some embodiments, the retaining clip may be configured to position the container holder in a substantially vertical position.

In some embodiments, the container holder may include a locking mechanism to secure the container holder to the retaining clip.

In some embodiments, the recess may be formed in a side wall of the container holder.

In further embodiments, the container holder may include a release button provided in the side wall of the container holder proximate to the recess. The release button may be configured to secure the container holder to the retaining clip and to release the container holder from the retaining clip when depressed.

In accordance with an aspect, there is provided a method of releasably securing a container holder to a clamp. The method may include securing the clamp to a frame of a stroller. The clamp may include a first clamping portion connectable to a second clamping portion by a hinge. The clamp further may include a retaining clip integrated into the clamp and may have a flange spaced a distance from an outer surface of the clamp. The method may include releasably securing the container holder to the flange of the retaining clip. The container holder may include a recess dimensioned to slide over the retaining clip on the frame of the stroller.

In some embodiments, the retaining clip may include a first section integrated into the first clamping portion and a second section integrated into the second clamping portion.

In some embodiments, when the clamp is secured to the frame of the stroller, the first section and the second section interconnect with one another to form the flange of the retaining clip.

In further embodiments, the first section and the second section, when engaged, may form a latch constructed and arranged to open the clamp when disengaged.

In some embodiments, the flange embodies an annular or polygonal, e.g., square, rectangular, pentagonal, hexagonal, or higher order n-gon, profile in cross-section.

In some embodiments, the container holder may be positioned orthogonally to the latch when mated to the retaining clip. The profile shape of the flange of the retaining clip may limit rotational motion of the container holder.

In some embodiment, the retaining clip may be configured to receive the recess of the container holder in a first position. In further embodiments, the retaining clip may maintain the container holder in a second position that is substantially vertical relative to the clamp.

In further embodiments, the method may include securing the container holder to the retaining clip by a locking mechanism.

In further embodiments, the method may include releasing the container holder from the retaining clip by pressing a release button.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIGS. 1A and 1B are left side and right side views, respectively, of a clamp having a retaining clip, according to one embodiment of the present disclosure;

FIG. 2A is an elevational view of the clamp shown in FIGS. 1A and 1B;

FIG. 2B is a rotated perspective view of the clamp;

FIG. 2C is a perspective view of the clamp secured to a left stroller frame member;

FIG. 2D is a perspective view of the clamp secured to a right stroller frame member;

FIG. 3A is an elevational view of a container holder, according to one embodiment of the present disclosure;

FIG. 3B is an elevational view of the container holder;

FIG. 4A is a perspective view of the container holder releasably secured to a clamp secured to a left frame member of a stroller; and

FIG. 4B is a perspective view of the container holder releasably secured to the clamp secured to a right frame member of a stroller.

### DETAILED DESCRIPTION

This disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

A conventional stroller typically has a partitioned pouch at the back side of the seat and/or a holding area or basket formed in a tray shape below the seat to hold and store various items, such as diapers, food items and the like. However, bottles or cups stored in such locations are not easily accessible. To address this problem, it is known to attach a holder dimensioned for beverage containers, e.g., cups and bottles, to a handlebar or frame of the stroller. A typical cup holder includes a cylindrical-shaped holder and an attachment clip which is connectable with the handlebar or stroller frame. The cylindrical-shaped holder, which can be detachable from the attachment clip, is typically adapted to secure the bottle or cup within the container. A drawback of the known cup holders is the manner by which the holder is attached to the stroller, which allows the cup holder to move on the handlebar or stroller causing the beverage held therein to tip and possibly spill within the stroller.

Aspects and embodiments disclosed herein are directed to a container holding system, e.g., for holding beverage containers or other objects of similar size. In one embodiment, the system includes a clamp configured to be mounted to a frame of a stroller or wagon, e.g., a siderail, handlebar, or other structural element of a stroller or wagon. The clamp may include a first clamping portion releasably connectable to a second clamping portion by a hinge. The system may include a retaining clip integrated into the clamp. The retaining clip may include a flange spaced a distance from an outer surface the clamp. The system further may include a container holder configured to be releasably secured to the flange of the retaining clip. The container holder may include a recess dimensioned to slide over the retaining clip on the frame of the stroller.

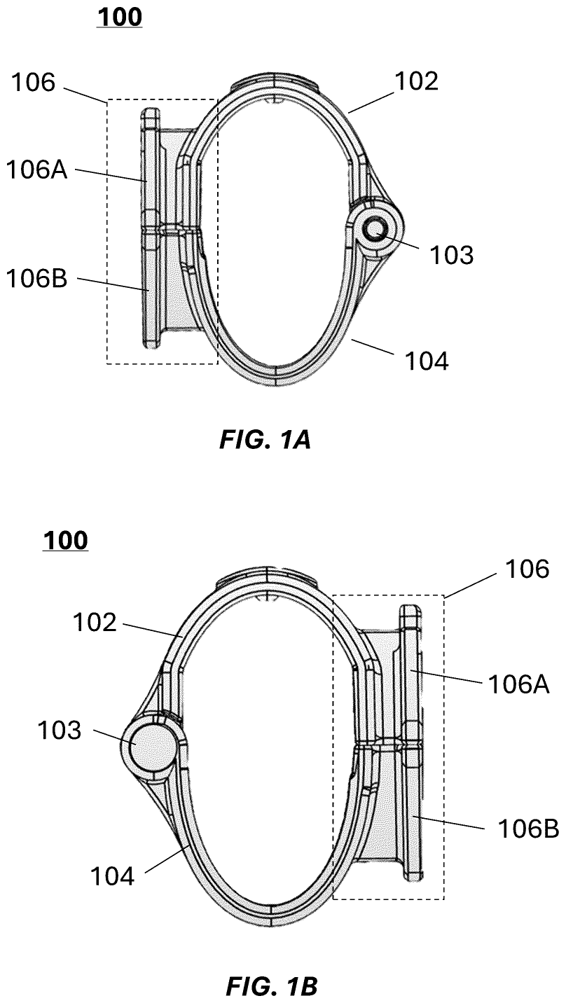

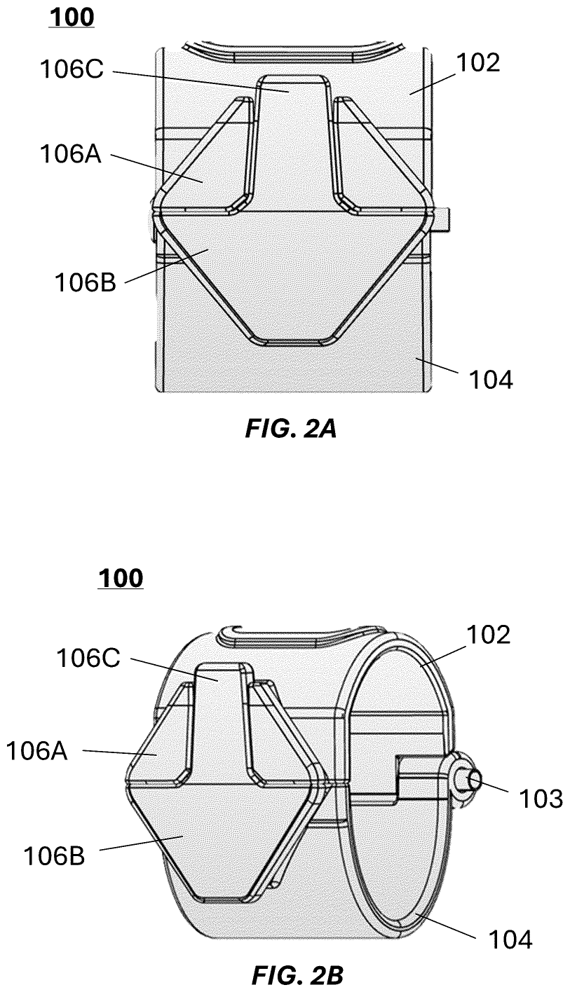

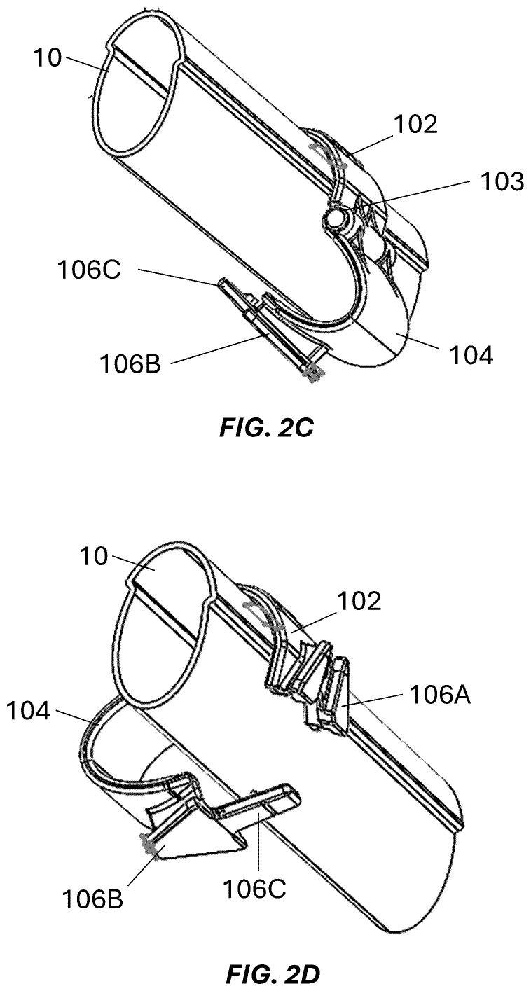

One embodiment of a clamp that is part of a container holding system is illustrated in FIGS. 1A, 1B, 2A, and 2B. The clamp 100 may be configured to be mounted or connected to a frame of a stroller or a wagon, such as at a handlebar or other frame component or member. The clamp 100 includes a first clamping portion 102 connectable to a second clamping portion 104 by a hinge 103. As illustrated, hinge 103 is made from rounded sections of each of the first clamping portion 102 and the second clamping portion 104 that have aperture extending therethrough. When the first clamping portion 102 and the second clamping portion 104 are brought into contact such that the apertures in the rounded portions of the first clamping portion 102 and the second clamping portion 104 are aligned, an appropriately dimensioned pin can be passed through the apertures and secured, e.g., peened, flattened, or adhered, to secure the first clamping portion 102 and the second clamping portion 104 together thereby forming hinge 103. Though hinge 103 is illustrated as a pin hinge, this is not limiting and other variations of a hinge are within the scope of this disclosure.

With continued reference to FIGS. 1A and 1B, clamp 100 includes a retaining clip 106 (shown in the dashed line box) integrated into the clamp 100. In one embodiment, the clip 106 is disposed on an opposing side of the clamp 100 of the hinge 103. The retaining clip 106 includes a flange that is spaced a distance from an outer surface of the clamp 100. The distance between the flange of the retaining clip 106 and the outer surface of the clamp 100 is such that another component of the container holding system, e.g., a container holder, can be attached to the retaining clip 106. The retaining clip 106 includes a first section 106A integrated into the first clamping portion 102 and a second section 106B integrated into the second clamping portion 104. When opened to be secured around a frame of a stroller or wagon, the clamp 100 is secured to the frame of the stroller by closing the clamp 100 such that the first section 106A and the second section 106B interconnect with one another to form the flange of the retaining clip 106.

With reference to FIGS. 2A and 2B, the retaining clip 106 includes a latch 106C that is configured to releasably secure the ends of the first section 106A and the second section 106B to secure the clamp 100 to the frame member of the stroller. As illustrated, the second section 106B includes a projection that is disposed between a corresponding space or recess in the first section 106A. The projection that forms latch 106C of the clamp 100 may include one or more securing feature, such as a hook, a tab, or a prong, that mates with a corresponding feature formed on the outer surface of the clamp 100 such that when engaged, the clamp is securely closed.

In operation, as illustrated in FIGS. 2C and 2D, the first clamping portion 102 and the second clamping portion 104 of the clamp 100 are disposed opposite one another over stroller frame member 10. To secure the first clamping portion 102 and the second clamping portion 104 of the clamp 100 to the stroller frame member 10, the ends of the first section 106A and the second section 106B are closed together to permit latch 106C to releasably connect to the outer surface of the clamp 100. As illustrated, this action permits the latch 106C to fit into the corresponding space or recess in the first section 106A where the securing feature of the latch 106 can be secured. The latch 106C can be opened, e.g., by pulling away the latch 106C from the outer surface of the clamp 100, to release the latch 106C, e.g., disengage the one or more securing features of latch 106C, and open the clamp 100.

The flange of the retaining clip 106 can be of any suitable shape. With respect to the illustrated flange shape in FIGS. 2A and 2B, the substantially straight and parallel sides of the flange do not permit any substantial rotation to a container holder when attached to the flange. The illustrated profile shape and orientation is only one embodiment and the disclosure is in no way limited by these illustrations. In some embodiments, the flange of the retaining clip 106 embodies an annular profile, e.g., circular, oval, or ellipsoidal, in cross section. In other embodiments, the flange of the retaining clip 106 has a polygonal, e.g., rhombic, parallelogram, square, rectangular, pentagonal, hexagonal, or higher order n-gon, profile in cross-section. As illustrated in FIGS. 2A-2D, the flange of the retaining clip 106 has a substantially square profile and is positioned in a diamond orientation on the clamp 100. The profile shape of the flange is used to limit rotational motion of any attached articles, such as a container holder.

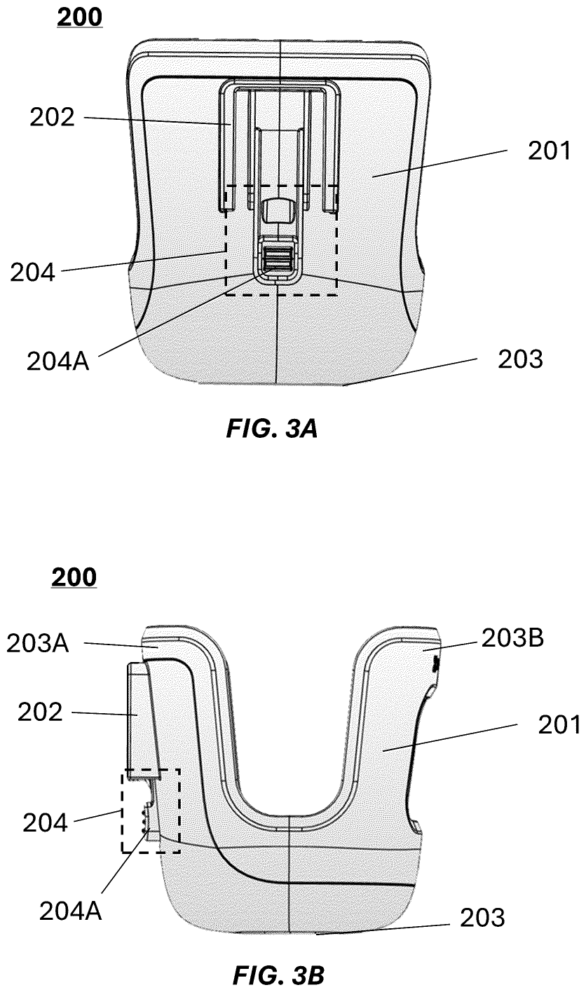

With reference to FIGS. 3A and 3B, the container holding system includes a container holder 200 configured to be releasably secured to the flange of the retaining clip 106 of the clamp 100. The container holder 200 includes a body 201 having a recess 202 formed therein, which is dimensioned to slide over the flange of the retaining clip 106 when the clamp 100 is secured to the frame of the stroller. The body 201 of the container holder 200 generally embodies a shape of a conventional beverage bottle holder, having a base 203 with a pair of opposing sidewalls 203A, 203B extending vertically from the base 203. The base 203 and the pair of opposing sidewalls 203A, 203B are used to provide support and stability to a container placed within the container holder. The base 203 and the pair of opposing sidewalls 203 may include additional structural elements that aid in stabilizing and supporting a container placed within the container holder, such as tension adjusting projections and textured or rubberized coatings to enhance grip of the container holder against a container placed within. As illustrated in FIGS. 3A and 3B, the recess 202 is formed in one of the sidewalls 203A, 203B of the container holder 200. As seen in FIG. 3A, the recess 202 includes appropriately dimensioned structural elements that permit mating with the flange of the retaining clip 106 of the clamp 100, such as ribs, slots, and tabs. The container holder 200 also includes a locking mechanism 204 (highlighted in the dashed line box in FIGS. 3A and 3B) that such that the container holder 200 can be mounted to the clamp 100 with a reduced likelihood of being disengaged unintentionally. The locking mechanism 204 of the container holder includes a release button 204 provided in the sidewall 203A, 203B of the container holder 200 proximate to the recess 202. The release button 204A is configured to secure the container holder 200 to the retaining clip 106 of the clamp 100 and to release the container holder 200 from the retaining clip 106 of the clamp 100 when the release button 204A is pressed. As a non-limiting example, the pressing of the release button 204A causes a deflection of a structural element of the locking mechanism 204, such as a latch or projection, causing disconnection from the flange of the retaining clip 106 of the clamp 100. Once the structural element of the locking mechanism 204 has been deflected away from the flange of the retaining clip 106 of the clamp 100, the container holder 200 can be removed from the clamp 100.

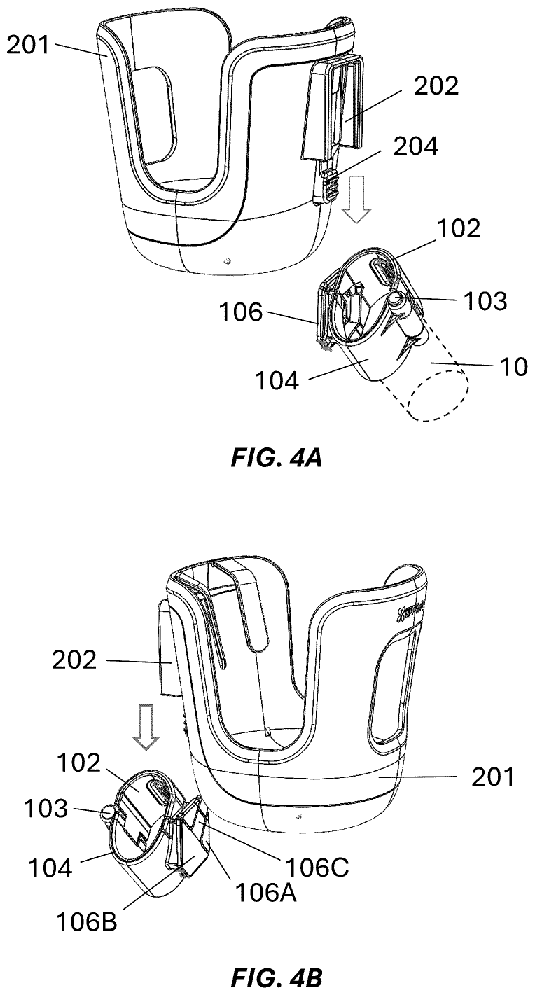

FIGS. 4A and 4B illustrate an embodiment of the clamp 100 secured to the frame of a stroller and a container holder 200 attached to the clamp 100. In FIG. 4A, the first clamping portion 102 and the second clamping portion 104 of the clamp 100 are disposed opposite one another over stroller frame member 10 such that the latch 106C of the retaining clip 100 is directed orthogonal to the stroller frame member 10. The clamp 100 can be connected to any portion of the frame of the stroller, such as either a left side of the stroller frame member (FIG. 4A) or the right side of the stroller frame member (FIG. 4B). In either position, the latch 106C of the retaining clip 106 will be oriented orthogonally with respect to the frame of the stroller.

As further illustrated, the latch 106C of the retaining clip 106 is generally disposed up towards the recess 202 of the container holder 200. The container holder 200 is attached to the clamp 100 by sliding the container holder 200 onto the clamp 100 from an elevated position with retaining clip 106 being slid into the recess 202 of the container holder as indicated by the arrows in FIGS. 4A and 4B. When mated together, the container holder 200 is generally positioned orthogonally to the latch 106C which maintains the container holder 202 in a position that is substantially vertical relative to the clamp 100. This positioning of the container holder 202 orthogonal to the latch 106C of the retaining clip 106 with the latch 106C pointing up towards the recess 202 reduces accidental opening of the latch 106C, and thus the clamp, when the container holder 200 is attached or detached from the clamp 100.

In accordance with an aspect, there is provided a method of releasably securing a container holder to a clamp. The method includes securing the clamp to a frame of a stroller. The clamp can be any clamp disclosed herein and includes a first clamping portion connectable to a second clamping portion by a hinge. The clamp further includes a retaining clip integrated into the clamp and has a flange spaced a distance from an outer surface of the clamp. The method includes releasably securing the container holder to the flange of the retaining clip. The container holder can be any container holder disclosed herein and includes a recess dimensioned to slide over the retaining clip on the frame of the stroller.

In some embodiments, the retaining clip includes a first section integrated into the first clamping portion and a second section integrated into the second clamping portion. When the clamp is secured to the frame of the stroller, the first section and the second section of the first clamping portion and second clamping portion, respectively, interconnect with one another to form the flange of the retaining clip. The first section and the second section of the first clamping portion and second clamping portion, respectively, when interconnected, form a latch constructed and arranged to open the clamp when disengaged.

In some embodiments, the flange embodies an annular or polygonal, e.g., square, rectangular, pentagonal, hexagonal, or higher order n-gon, profile in cross-section. The profile shape of the flange of the retaining clip limits rotational motion of the container holder. The profile shape of the flange of the retaining clip is configured to position the container holder in a substantially vertical position. The container holder is positioned orthogonally to the latch when mated to the retaining clip.

In further embodiments, the method includes securing the container holder to the retaining clip by a locking mechanism, e.g., as disclosed herein.

In further embodiments, the method includes releasing the container holder from the retaining clip by pressing a release button, e.g., as disclosed herein.

Having thus described several aspects of at least one embodiment, it is to be appreciated that various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only. Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A container holding system, comprising:
a clamp configured to be mounted on a frame of a stroller, the clamp including a first clamping portion connectable to a second clamping portion by a hinge;
a retaining clip integrated into the clamp, the retaining clip including a flange spaced a distance from an outer surface of the clamp; and
a container holder configured to be releasably secured to the flange of the retaining clip, the container holder including a recess dimensioned to slide over the retaining clip on the frame of the stroller.

2. The system of claim 1, wherein the retaining clip includes a first section integrated into the first clamping portion and a second section integrated into the second clamping portion.

3. The system of claim 2, wherein, when the clamp is secured to the frame of the stroller, the first section and the second section interconnect with one another to form the flange of the retaining clip.

4. The system of claim 3, wherein the first section and the second section further form a latch constructed and arranged to open the clamp when disengaged.

5. The system of claim 4, wherein the flange embodies an annular or polygonal profile in cross-section.

6. The system of claim 4, wherein the container holder, when mated to the retaining clip, is positioned orthogonally to the latch.

7. The system of claim 6, wherein a profile of the flange of the retaining clip limits rotational motion of the container holder.

8. The system of claim 7, wherein the retaining clip is configured to be received the recess of the container holder.

9. The system of claim 8, wherein the retaining clip maintains the container holder in a position that is substantially vertical relative to the clamp.

10. The system of claim 1, wherein the container holder includes a locking mechanism to secure the container holder to the retaining clip.

11. The system of claim 1, wherein the recess is formed in a side wall of the container holder.

12. The system of claim 11, wherein the container holder includes a release button provided in the side wall of the container holder proximate to the recess, the release button being configured to secure the container holder to the retaining clip and to release the container holder from the retaining clip when pressing the release button.

13. A method of releasably securing a container holder to a clamp, the method comprising:
securing the clamp to a frame of a stroller, the clamp including a first clamping portion connectable to a second clamping portion by a hinge, the clamp including a retaining clip integrated into the clamp, the retaining clip including a flange spaced a distance from an outer surface of the clamp; and
releasably securing the container holder to the flange of the retaining clip, the container holder including a recess dimensioned to slide over the retaining clip independent of an orientation of the clamp on the frame of the stroller.

14. The method of claim 13, wherein the retaining clip includes a first section integrated into the first clamping portion and a second section integrated into the second clamping portion.

15. The method of claim 14, wherein, when the clamp is secured to the frame of the stroller, the first section and the second section interconnect with one another to form the flange of the retaining clip.

16. The method of claim 15, wherein the first section and the second section further form a latch constructed and arranged to open the clamp when disengaged.

17. The method of claim 16, wherein the flange embodies an annular or polygonal profile in cross-section.

18. The method of claim 17, wherein the container holder, when mated to the retaining clip, is positioned orthogonally to the latch, and
wherein a profile of the flange of the retaining clip limits rotational motion of the container holder.

19. The method of claim 18, wherein the retaining clip is configured to receive the recess of the container holder in a first position.

20. The system of claim 19, wherein the retaining clip maintains the container holder in a second position that is substantially vertical relative to the clamp.

21. The method of claim 13, further comprising securing the container holder to the retaining clip by a locking mechanism.

22. The method of claim 13, further comprising releasing the container holder from the retaining clip by pressing a release button.
